(19) United States
(12) Patent Application Publication
(10) Pub. No.: US 2009/0031351 A1
(43) Pub. Date: Jan. 29, 2009

(54) Apparatus and Method for Setting Broadcasting Program as a Background Image, and Portable Device Using the Same

(76) Inventor: Sang-Hyun Kim, Gyeonggi-do (KR)

Correspondence Address: HARNESS, DICKEY & PIERCE, P.L.C., P.O. BOX 8910, RESTON, VA, 20195, US

(21) Appl. No.: 12/224,431

(22) PCT Filed: Feb. 20, 2007
(86) PCT No.: PCT/KR2007/000880

§ 371 Date: Aug. 27, 2008

(30) Foreign Application Priority Data
Feb. 28, 2006 (KR) 10-2006-0019574

(51) Int. Cl. H04N 5/445

(52) U.S. Cl. 725/39

(57) ABSTRACT

A method of providing a background image in a portable device includes extracting broadcasting signals of broad-casting channels in a given order on the basis of a background image setting information, and displaying broadcasting images corresponding to the broadcasting signals as the background image on corresponding displaying areas of the portable device. In the method, broadcasting image(s) of predetermined broadcasting channels are used as the background image of the portable device, and thus a moving image as well as a still image may be set as the background image of the portable device.

### TECHNICAL FIELD

Example embodiments of the present invention relates to methods and apparatuses for setting a background image, and more particularly relates to methods and apparatuses for setting a background image in a portable device.

### BACKGROUND ART

Recently, a portable device having a function of receiving a broadcasting program as well as conventional voice call function has been developed.

Electronic program guide (hereinafter, referred to as EPG) information transmitted from a broadcasting center includes a title of broadcasting programs related to each of broadcasting channels. A portable device stores the transmitted EPG information in a memory included therein. In this case, a user searches the EPG information stored in the memory, and then selects a desired broadcasting program through the searched EPG information.

The portable device separates one of broadcasting program information from an inputted bit stream only based on the EPG information when a user wants to watch desired broadcasting program, decodes the separated broadcasting program information, and then displays an image corresponding to the decoded broadcasting program information thereon. That is, broadcasting guide information and moving image information that are at present transmitted to the portable device from the broadcasting center are discarded at ordinary times.

Korean Patent Application Publication No. 2005-44844 discloses a portable device which displays a sliding text-type broadcasting guide on a background image by using received EPG information. However, the disclosed device does not also utilize efficiently various moving image information related to broadcasting channels as a background image, and displays only EPG information on the background image.

### DISCLOSURE OF INVENTION

### Technical Problem

Accordingly, the present invention is provided to substantially obviate one or more problems due to limitations and disadvantages of the related art.

It is a feature of the present invention to provide methods of setting a background image for the purpose of using a broadcasting program of a broadcasting channel as a background image of a portable device.

It is another feature of the present invention to provide apparatuses of setting a background image for the purpose of using a broadcasting program of a broadcasting channel as a background image of a portable device.

It is still another feature of the present invention to provide a portable device for the purpose of using a broadcasting program of a broadcasting channel as a background image.

### Technical Solution

In one example embodiment, a method of providing a background image in a portable terminal includes extracting broadcasting signals of broadcasting channels in a given order on the basis of a background image setting information; and displaying broadcasting images corresponding to the broadcasting signals as the background image on corresponding displaying areas of the portable device.

The broadcasting image corresponding to frames extracted as one frame for every unit of k frames from each of the broadcasting images is displayed on a corresponding displaying area, and wherein k is a natural number. Here, a value of k varies depending upon the displaying areas.

One of the broadcasting images displayed on each of the displaying areas are updated at a time.

The step of displaying the broadcasting images includes displaying a still image corresponding to a specific frame in each of the broadcasting signals of the broadcasting channels on a corresponding displaying area; and displaying a moving image corresponding to frames extracted in sequence one in unit of k frames from each of the broadcasting signals of the broadcasting channels on the corresponding displaying area after a given time from a time point of the displaying the still image, wherein k is a natural number.

When one of the displaying areas is selected by a key inputting event, a broadcasting image of a broadcasting channel corresponding to the selected displaying area is played with a full screen on the portable device. In case that one of the displaying areas is selected by the key inputting event, detailed information concerning a broadcasting channel corresponding to the selected displaying area is displayed.

The broadcasting channels are demodulated by using a plurality of tuners and demodulators.

The broadcasting channels are demodulated by using one tuner and one demodulator.

At least one of the broadcasting channels include one of a terrestrial DMB channel and a satellite DMB channel.

An audio output of a predetermined broadcasting channel is activated during the displaying the broadcasting images.

The method of providing the background image in the portable device is performed during an idle status of the portable device.

The method of claim 1, further includes setting the background image setting information having the broadcasting channels to be used as the background image of the portable device.

The background image setting information includes at least one of a displaying area information representing displaying areas corresponding to each of the broadcasting channels and an information representing a broadcasting channel of which audio output is enabled.

The displaying areas are formed by dividing a background screen of the portable device into N areas, and wherein N is a natural number equal to or greater than two.

In one example embodiment, an apparatus for providing a background image in a portable device includes a broadcasting receiving section configured to extract broadcasting signals of broadcasting channels in a given order on the basis of a background image setting information; and a background image processing section configured to decode the extracted broadcasting signals, and configured to display broadcasting images corresponding to the decoded broadcasting signals as the background image on corresponding displaying areas of the portable device.

The background image processing section displays an image corresponding to frames extracted in sequence one in unit of k frames from each of the broadcasting channels on corresponding displaying area, wherein k is a natural number.

The broadcasting receiving section has tuners and demodulators.

The broadcasting receiving section has one tuner and one demodulator.

In another example embodiment, a portable device includes a broadcasting receiving section configured to extract broadcasting signals of broadcasting channels in a given order on the basis of background image setting information; and a background image processing section configured to decode the extracted broadcasting signals, and configured to display broadcasting images corresponding to the decoded broadcasting signals as a background image on corresponding displaying areas.

Frames extracted in sequence one in unit of k frames from each of the broadcasting channels are displayed on corresponding displaying area in given order.

In another example embodiment, a method of providing a background image in a portable device includes extracting a broadcasting signal of a broadcasting channel on the basis of a background image setting information; and displaying a broadcasting image of the broadcasting channel as a background image on at least one of displaying areas of the portable device during an idle status of the portable device.

The step of the extracting a broadcasting signal includes extracting a plurality of frames from the broadcasting channel on the basis of the background image setting information, the frames being different from one another, and wherein the step of the displaying a broadcasting image includes displaying the extracted frames as the background image on one displaying area, the extracted frames being sequentially displayed in a given interval.

The step of the extracting a broadcasting signal includes extracting a plurality of frames from the broadcasting channel on the basis of the background image setting information, the frames being different from one another, and wherein the step of the displaying a broadcasting image includes displaying the extracted frames as the background image on a plurality of displaying areas, the extracted frames being sequentially displayed in a given interval.

In still another example embodiment, a method of providing a background image in a portable device includes extracting broadcasting signals of broadcasting channels on the basis of a background image setting information; and displaying broadcasting images corresponding to the broadcasting signals of the broadcasting channels as a background image on a displaying area of the portable device during an idle status of the portable device, the broadcasting images being displayed in a given interval on the displaying area.

The background image setting information has an information representing the broadcasting channels to be set as the background image.

The background image setting information further includes an information representing an enable of an audio output of one of the broadcasting channels.

In still another example embodiment, a portable device includes a broadcasting receiving section configured to extract a broadcasting signal of one broadcasting channel on the basis of a background image setting information; and a background image processing section configured to display a broadcasting image corresponding to the broadcasting signal of the broadcasting channel as a background image on at least one displaying area of the portable device during an idle status of the portable device.

In still another example embodiment, a portable device includes a broadcasting receiving section configured to extract broadcasting signals of broadcasting channels on the basis of background an image setting information; and a background image processing section configured to display broadcasting images corresponding to the broadcasting signals of the broadcasting channels as a background image on a displaying area of the portable device during an idle status of the portable device, the broadcasting images being displayed in a given interval on the displaying area.

### Advantageous Effects

In methods and apparatuses for setting a background image of a portable terminal, a broadcasting image(s) of predetermined broadcasting channels among a plurality of broadcasting channels is(are) used as the background image of the portable terminal, and thus a moving image as well as a still image may be set as the background image of the portable terminal. Accordingly, an image generated by combining various moving images and/or still images of various broadcasting channels being transmitted at the present time may be set as the background image according to a preference of a user. Further, the user may monitor broadcasting channels to which the user has usually an interest.

Moreover, the methods and apparatuses may provide broadcasting programs corresponding to a plurality of broadcasting channels to a user of a portable device so that the user previews the broadcasting program.

### BRIEF DESCRIPTION OF THE DRAWINGS

Example embodiments of the present invention will become more apparent by describing in detail example embodiments of the present invention with reference to the accompanying drawings, in which:

FIG. 1 is a flowchart illustrating a process of setting a background image according to one example embodiment of the present invention;

FIG. 2 is a view illustrating a screen for setting the background image in accordance with FIG. 1;

FIG. 3 is a flowchart illustrating a method of providing the background image according to one example embodiment of the present invention;

FIG. 4 is view illustrating a background image set in accordance with the setting of the background image of FIG. 2;

FIG. 5 is a view illustrating a screen when a broadcasting image of a specific broadcasting channel is focused in the background image in FIG. 4;

FIG. 6 is a view illustrating a process of updating the background image while broadcasting channels are shifted;

FIG. 7 is a block diagram illustrating an apparatus for providing a background image according to one example embodiment of the present invention;

FIG. 8 is a block diagram illustrating an apparatus for providing a background image according to another example embodiment of the present invention; and

FIG. 9 is a block diagram illustrating a mobile communication device employing the apparatus for providing a background image according to one example embodiment of the present invention.

### MODE FOR THE INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a broadcasting includes a digital TV broadcasting. That is, the broadcasting includes a terrestrial digital multimedia broadcasting (DMB), a satellite DMB and a digital video broadcasting (DVB) employed in Europe.

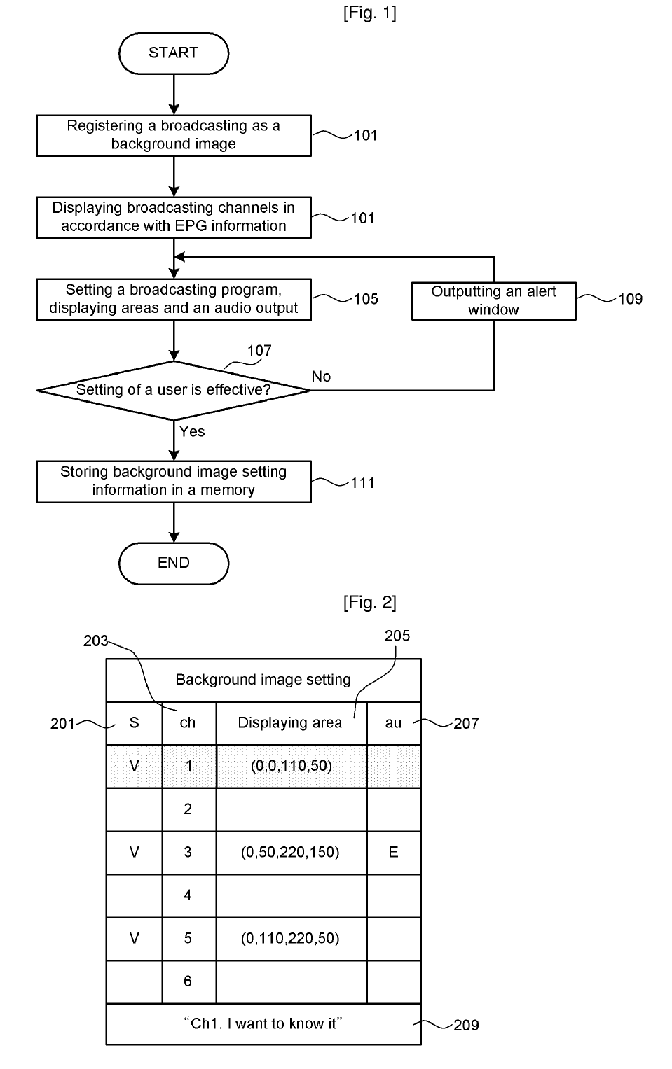

FIG. 1 is a flowchart illustrating a process of setting a background image according to one example embodiment of the present invention. FIG. 2 is a view illustrating a screen for setting the background image in accordance with FIG. 1.

Hereinafter, a background image registration processing routine for setting the background image will be described in detail.

Referring to FIG. 1, in case that a user selects a registration function of registering a broadcasting as a background image in step of S101, a portable device parses electronic program guide (hereinafter, referred to as EPG) information from a received bit stream to obtain broadcasting program information, and displays broadcasting channels which is possible to be received at the present time with a table thereon as shown in FIG. 2 in step of S103.

Referring to FIG. 2, a selecting item (S) 201, a channel item (CH) 203 for indicating broadcasting channels which is possible to be received at the present time, a displaying area setting item 205 and an audio item 207 are displayed on a background image registration screen. Here, the user selects broadcasting channel used as a background image through the selecting item (S) 201, and designates a displaying area where the broadcasting channel corresponding to the background image is displayed through the displaying area setting item 205. In addition, the user selects whether or not activating an audio through the audio item 207.

In step of S105, the user selects a broadcasting program of the broadcasting channel to be used as the background image on the background image registration screen, sets the displaying area and sets whether or not the activating the audio output.

FIG. 2 shows a screen that the user selects channels 1, 3 and 5 of six channels 1 to 6 as channel related to the background image, sets the displaying areas corresponding to the selected channels 1, 3 and 5, and sets to output broadcasting program of the channel 3 with an audio by using a speaker or an earphone, etc. Here, in case that the broadcasting program of the channel 3 corresponds to a video program, the broadcasting program is outputted with both of a video and an audio. However, in case that the broadcasting program corresponds to an audio program, the broadcasting program is outputted with only an audio.

In step of S107, it is determined whether or not the background image setting of the user is effective. In case that the background image setting is not effective, e.g. displaying areas of selected broadcasting programs are overlapped or an audio is set to be played through a speaker in a manner mode, etc., an alert window is outputted in step of S109, and then the step of S105 is performed again.

In step of S111, in case that the background image setting is effective, the background image setting information set by the user is stored. For example, the background image setting information may be stored in a non-volatile memory.

In the above FIG. 2, the broadcasting programs of broadcasting channels are set as the background image. However, broadcasting program of only one broadcasting channel may be set as the background image. In this case, the set broadcasting channel may be assigned on whole of background screen of the portable device, i.e. one displaying area, or be assigned on a plurality of displaying areas.

In case that the set broadcasting channel is assigned on the whole background screen, frames extracted as one frame for every unit of given number of frames from broadcasting signal of the broadcasting channel may be assigned on the whole background screen. For example, nth frame, (n+k)th frame, (n+2k)th frame, etc, i.e. frames extracted as one frame for every unit of k frames are assigned on the whole background screen, wherein k is natural number.

In case that the broadcasting channel is assigned on the displaying areas, frames extracted from broadcasting signal of the broadcasting channel may be assigned on the displaying areas, and wherein the extracted frames are different one another. For example, in case that the displaying areas are composed of a first displaying area, a second displaying area and a third displaying area, nth frame, (n+k)th frame and (n+2k)th frame are respectively assigned on the first through third displaying areas, wherein k is natural number.

In another embodiment of the present invention, a plurality of broadcasting channels may be assigned in sequence to the whole background screen, i.e. one displaying area.

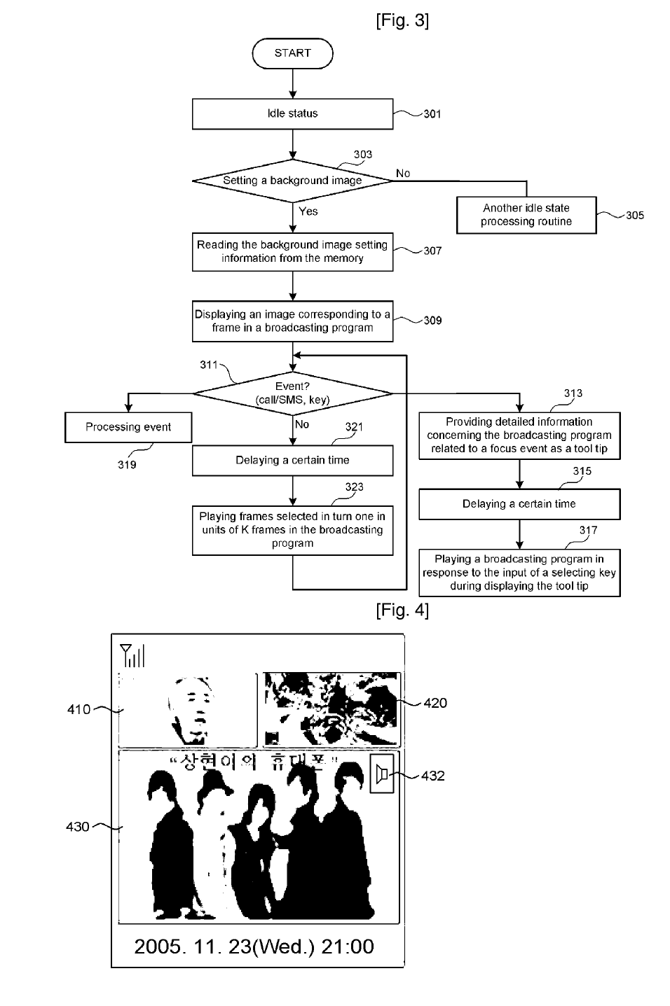

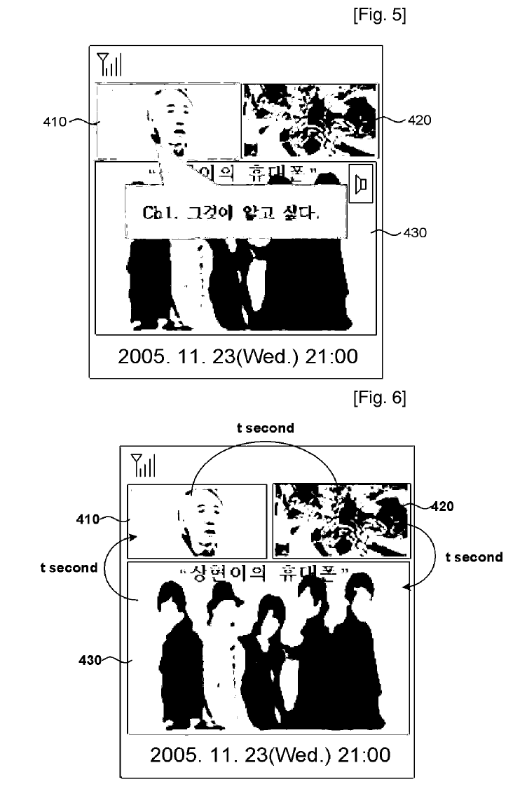

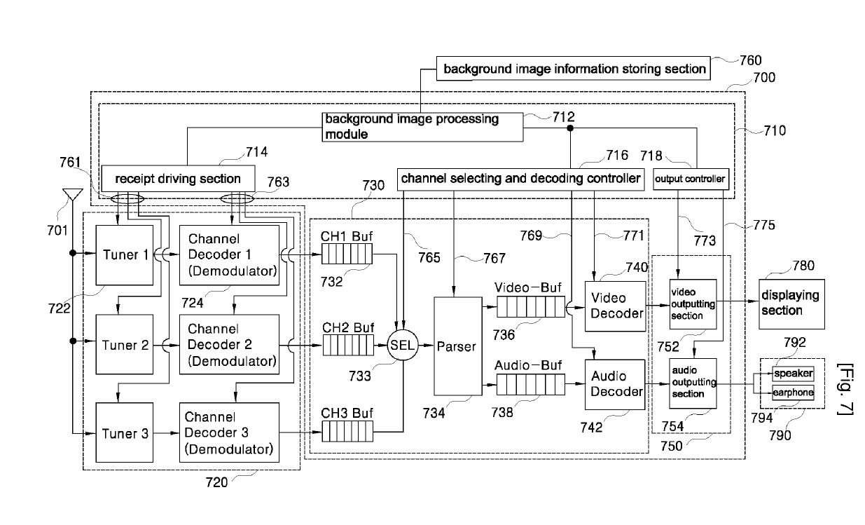

FIG. 3 is a flowchart illustrating a method of providing the background image according to one example embodiment of the present invention, and FIG. 4 is view illustrating a background image set in accordance with the setting of the background image of FIG. 2. FIG. 5 is a view illustrating a screen when a broadcasting image of a specific broadcasting channel is focused in the background image in FIG. 4, and FIG. 6 is a view illustrating a process of updating the background image while broadcasting channels are shifted.

In case that the portable device has idle state and a liquid crystal display (LCD) is turned on, the portable device calls a background image update processing routine after delaying a constant time.

Hereinafter, the operation of the background image update processing routine will be described in detail.

Referring to FIG. 3, in step of S303, it is verified whether or not the background image is set while the portable device has idle state in step of S301.

In step of S305, another idle state processing routine is performed in case that the background image is not set. However, in step of S307, in case that the background image is set, the background image setting information is read from the non-volatile memory, etc.

In step of S309, a specific frame in broadcasting program of each of channels registered as the background image is read, and then specific image corresponding to the read frame is displayed as the background image. Here, the specific images are still images.

As shown in FIG. 4, a first still image corresponding to a given frame in a broadcasting program of the channel 1 is displayed on a first displaying area 410, and a second still image corresponding to a given frame in a broadcasting program of the channel 5 is displayed on a second displaying area 420. Additionally, a third still image corresponding to a given frame in a broadcasting program of the channel 3 is displayed on a third displaying area 430.

In the above FIG. 4, the broadcasting programs of broadcasting channels are displayed on the displaying areas. However, frames extracted from broadcasting signal of only one broadcasting channel may be displayed on the displaying areas. For example, in case that the displaying areas are composed of a first displaying area, a second displaying area and a third displaying area, nth frame, (n+k)th frame and (n+2k)th frame are respectively displayed on the first through third displaying areas, wherein k is natural number.

In another embodiment of the present invention, frames extracted as one frame for every unit of given number of frames from broadcasting signal of one broadcasting channel may be displayed in sequence on the whole background screen, i.e. one displaying area. For example, nth frame, (n+k)th frame, (n+2k)th frame, etc, i.e. frames extracted as one frame for every unit of k frames are displayed in sequence on the whole background screen, wherein k is natural number.

In still another embodiment of the present invention, broadcasting programs of broadcasting channels may be displayed in sequence on the whole background screen.

In the above step S309, the still image is displayed on each of the displaying areas. However, a moving image comprised of frames extracted as one frame for every unit of given number of frames from broadcasting signal of given broadcasting channel may be displayed on a corresponding displaying area.

In step of S311, it is detected whether or not an event such as a call, a SMS, input of a key, etc. is occurred during the operation of the background image update processing routine.

In step of S313, in case that it is detected that a focus event is occurred by moving a direction key into a broadcasting program of a specific broadcasting channel, detailed information concerning the broadcasting program related to the focus event is provided as a tool tip. For example, in case that a user shifts the direction key to focus the broadcasting program of the channel 1 of the first displaying area as shown in FIG. 5, detailed information concerning the focused broadcasting program such as channel number, program title, etc. is provided as the tool tip.

In step of S315, a given time (t) is delayed from the provision of the detailed information.

In step of S317, in case that one of the displaying areas is selected by manipulating a selecting key during displaying the detailed information concerning the focused broadcasting program, a broadcasting of the broadcasting channel corresponding to the selected displaying area is played with full screen on the portable device by executing a broadcasting playing application so that the user can watch the broadcasting related to the selected displaying area. Here, the time (t) may be several seconds, e.g. 2 seconds to 5 seconds. Then, the background image update processing routine is finished and the portable device gets out of the idle status.

In step of S321, a given time (t) is delayed in case that the focus event is not occurred.

In step of S323, broadcasting signals having broadcasting programs of the broadcasting channels selected as the background image by the user are selected in sequence with a predetermined order, e.g. order of the first displaying area 410, the second displaying area 420 and the third displaying area 430 as shown in FIG. 6, and are decoded. In this process, frames selected in sequence one in period of k frames in the broadcasting program of each of the selected broadcasting channels are displayed on corresponding displaying area. Here, k may be natural number. For instance, in case that a moving image is played with rate of 30 frames per second in a normal broadcasting, the moving image may be played with rate of 15 frames per second when the received broadcasting is used as the background image, wherein k is 1. Here, k may have the same value irrespective of the displaying areas, or have different values in accordance with the displaying areas. For example, k is 1 in the first and third displaying areas, and is 2 in the second displaying area.

In this case, the background image may be updated simultaneously with background information of the portable device such as a receiving sensitivity, a receipt notice of a message and a charging condition of a battery and so on via an overlay process.

The broadcasting programs in each of the displaying areas may be updated one by one after delaying the time to reduce the load of a central processing unit in the portable device. In case that the portable device has again idle state, the step S301 is performed again.

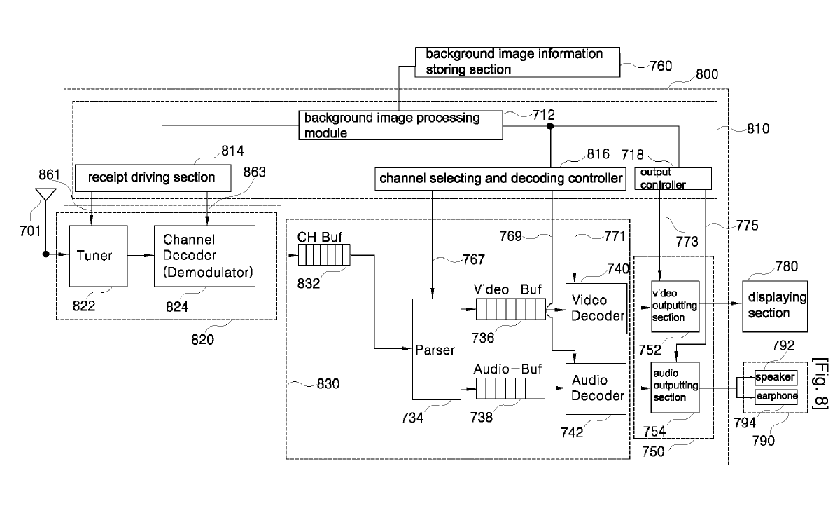

FIG. 7 is a block diagram illustrating an apparatus for providing a background image according to one example embodiment of the present invention.

In FIG. 7, the apparatus for providing the background image includes an antenna 701, a broadcasting receiving section 720, a background image processing section 700, a displaying section 780, a sound outputting section 790 and a background image information storing section 760.

The background image information storing section 760 stores a plurality of broadcasting channel information set as the background image by a user, displaying area information of broadcasting channel set as the background image and information concerning to a broadcasting channel set to enable audio output by the user. Here, the background image information storing section 760 may be a non-volatile memory such as a flash memory, etc.

The background image processing section 700 includes a background image processing controller 710, a demodulating section 730 and an outputting section 750.

The background image processing controller 710 may have a background image processing module 712, a receipt driving section 714, a channel selecting and decoding controller 716 and an output controller 718.

The background image processing module 712 receives the broadcasting channel information, the displaying area information and the information set to enable audio output from the background image information storing section 760. Then, the background image processing module 712 controls the receipt driving section 714, the channel selecting and decoding controller 716 and the output controller 718 using the received information so that the background image registration processing routine in FIG. 1 and the background image update processing routine in FIG. 3 are performed. Further, the background image processing controller 710 controls the receipt driving section 714 and the channel selecting and decoding controller 716 so that a broadcasting channel corresponding to one displaying area selected from the displaying areas is displayed when a key event for selecting the displaying area is occurred by the user.

The receipt driving section 714 drives tuners 722 and channel decoders 724 to obtain bit stream related to the broadcasting channels with changing the broadcasting channels in a given order by the background image update processing routine. Here, the broadcasting channels are set as the background image. In addition, the receipt driving section 714 receives the information concerning the broadcasting channel corresponding to one of the displaying areas from the background image information storing section 760 when a key event for selecting one is occurred by the user, and controls to select the tuner related to the broadcasting channel corresponding to the selected displaying area by using the received information. Moreover, the receipt driving section 714 outputs a channel selecting signal 761 to each of the tuners 722, and outputs a channel decoder enable signal 763 to the each of the channel decoders 724.

The channel selecting and decoding controller 716 outputs a buffer selecting signal 765 for selecting one of the channel buffers 732 at a predetermined time to a buffer selecting section 733, and outputs a parsing controlling signal 767 to a parser 734, thereby parsing video information and audio information. Additionally, the channel selecting and decoding controller 716 outputs a video decoding controlling signal 771 and an audio decoding controlling signal 769 to a video decoder 740 and an audio decoder 742, respectively. Further, the channel selecting and decoding controller 716 receives the information concerning the broadcasting channel corresponding to one of the displaying areas from the background image processing controller 710 when the key event for selecting the one is occurred by the user, and then outputs the buffer selecting signal 765 for selecting a channel buffer related to the broadcasting channel corresponding to the selected displaying area to the buffer selecting section 733 in accordance with the received information.

The channel selecting and decoding controller 716 may be made up of one block as shown in FIG. 7, or be made up of a channel selecting section and a decoding controller.

The output controller 718 transmits a video output controlling signal 773 and an audio output controlling signal 775 to a video outputting section 752 and an audio outputting section 754, respectively. Additionally, the output controller 718 controls the video outputting section 752 and the audio outputting section 754 through the transmission of the signals 773 and 775 to output a decoded video signal and a decoded audio signal to the displaying section 780 and the sound outputting section 790. As a result, the displaying section 780 displays the background image corresponding to the decoded video signal on the corresponding displaying area with a given period, and the sound outputting section 790 outputs a sound corresponding to the decoded audio signal.

The broadcasting receiving section 720 includes the tuners 722 and the channel decoders 724 (or demodulator) connected electrically to the tuners 722. Hereinafter, it is assumed that the broadcasting receiving section 720 has three tuners 722 and three channel decoders 724 (or demodulators).

Each of the tuners 722 extracts a specific frequency signal corresponding to the broadcasting channels from a high frequency signal (RF signal) received through the antenna 701 in response to the channel selecting signal 761, converts the specific frequency signal into a base band signal, and then transmits the converted frequency signal to corresponding channel decoder 724. Here, the broadcasting channel may be a terrestrial DMB channel, a satellite DMB channel, and a DVB channel, etc.

Each of the channel decoders 724 demodulates video information, audio information and broadcasting program information, etc. from the bit stream in each of the broadcasting channels in response to the channel decoder enable signal 763 transmitted from the receipt driving section 714, and then transmits the demodulated information to the demodulating section 730. Here, the video information may be video data coded in accordance with MPEG4 (H.264) standard or MPEG2 standard. Further, the audio information may be audio data coded in accordance with advanced audio coding (AAC) or bit sliced audio coding (BSAC).

The decoding section 730 includes the channel buffers 732, the buffer selecting section 733, the parser 734, a video buffer 736, an audio buffer 738, the video decoder 740 and the audio decoder 742.

The channel buffers 732 store respectively demodulated packet streams corresponding to the broadcasting channels in accordance with the channels.

The buffer selecting section 733 selects one of the channel buffers 732 in response to the buffer selecting signal 765 transmitted from the background image processing controller 710, and outputs a packet stream stored in the selected channel buffer to the parser 734.

The parser 734 parses video information and audio information from the packet stream outputted from the buffer selecting section 733 in response to a parsing controlling signal 767 transmitted from the background image processing controller 710, transmits the parsed video information to the video buffer 736, and provides the parsed audio information to the audio buffer 738.

The video decoder 740 decodes the video information stored in the video buffer 736 in response to the video decoding controlling signal 771, and outputs the decoded video information. Here, the video information is decoded with reference to audio(A)/video(V) synchronization.

The audio decoder 742 decodes the audio information stored in the audio buffer 738 in response to an audio decoding controlling signal 769 when the audio information corresponds to a broadcasting channel set to enable audio output by the user, and outputs the decoded audio information. Here, the audio information is decoded with reference to audio(A)/video(V) synchronization.

The outputting section 750 includes a video outputting section 752 and an audio outputting section 754.

The video outputting section 752 provides the video information decoded by the video decoder to the displaying section 780 in response to the video output controlling signal 773. In this case, the displaying section 780 displays periodically an image corresponding to the provided video information on the displaying area set as the background image by the user. Here, the displaying section 780 may be for example liquid crystal display (LCD).

The audio outputting section 754 provides the audio information decoded by the decoder 742 to a sound outputting section 790 in response to the audio output controlling signal 775. In this case, the sound outputting section 790 outputs a sound corresponding to the provided audio information at a given time, and may have a speaker 792 and an earphone 794.

The apparatus and method of providing the background image according to one embodiment of the present invention multiplexes the broadcasting receiving section 720 using tuners and demodulators and buffers a little of information to the channel buffer 732, thereby reducing a time delay, e.g. 2-3 seconds when the broadcasting channels corresponding to the background image are changed. In addition, an audio of a specific channel selected by the user may be continuously outputted during displaying the background image.

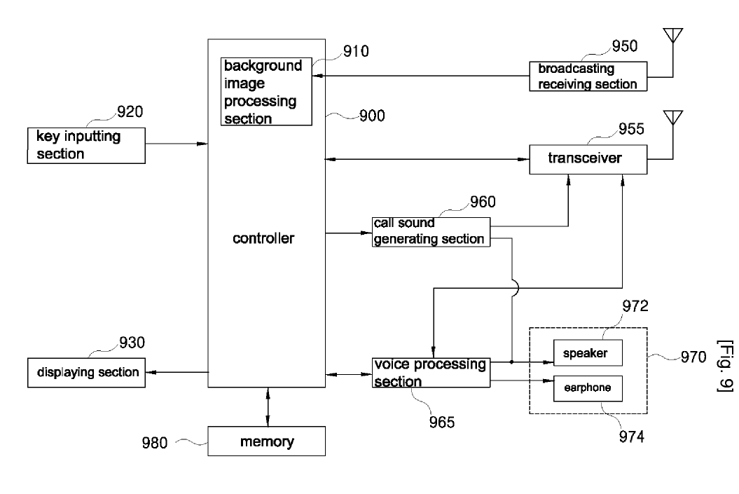

FIG. 8 is a block diagram illustrating an apparatus for providing a background image according to another example embodiment of the present invention. Here, the apparatus employs one tuner, one channel decoder and one channel buffer unlike the apparatus for providing the background image in FIG. 7.

A receipt driving section 814 drives a tuner 822 and a channel decoder 824 for a background image update processing routine to obtain packet streams of broadcasting channels with changing periodically the broadcasting channels in accordance with a given order.

The receipt driving section 814 receives the information concerning the broadcasting channel corresponding to one of the displaying areas from a background image processing controller 810 when a key event for selecting the one is occurred by the user, and controls the tuner 822 using the received information so that a broadcasting program of a broadcasting channel corresponding to the selected displaying area is selected. In addition, the receipt driving section 814 outputs a channel selecting signal 861 to the tuner 822, and transmits a channel decoder enable signal 863 to the channel decoder 824.

The channel selecting and decoding controller 816 outputs a parsing controlling signal 767 to a parser 734, thereby parsing video information and audio information, and outputs a video decoding controlling signal 771 and an audio decoding controlling signal 769 to a video decoder 740 and an audio decoder 742, respectively. Further, the channel selecting and decoding controller 816 may be made up of one block as shown in FIG. 8, or be made up of a channel selecting section and a decoding controller.

A output controlling section 718 transmits a video output controlling signal 773 and an audio output controlling signal 775 to a video outputting section 752 and an audio outputting section 754, respectively, and controls the video outputting section 752 and the audio outputting section 754 to output a decoded video signal and a decoded audio signal to the displaying section 780 and the sound outputting section 790. As a result, the displaying section 780 displays the background image corresponding to the decoded video signal on the corresponding displaying area with a given period, and the sound outputting section 790 outputs a sound corresponding to the decoded audio signal.

A broadcasting receiving section 820 includes one tuner 822 and one channel decoder 824 connected electrically to the tuner 822.

The tuner 822 extracts a plurality of frequency signals corresponding to broadcasting channels from a high frequency signal (RF signal) received periodically through the antenna 701 in response to a channel selecting signal 861, converts the frequency signals into a base band signals, and then transmits the converted frequency signals to the channel decoder 824. Here, the broadcasting channel may be a terrestrial DMB channel, a satellite DMB channel, and a DVB channel, etc.

The channel decoder 824 demodulates video information, audio information and broadcasting program information, etc. from the bit stream in a broadcasting channel selected at the present time in response to a channel decoder enable signal 863, and then transmits the demodulated information to the demodulating section 830.

The demodulating section 830 includes a channel buffer 832, a parser 734, a video buffer 736, an audio buffer 738, a video decoder 740 and an audio decoder 742.

The channel buffer 732 stores a packet stream demodulated by the demodulating section 830, wherein the packet stream corresponds to the selected broadcasting channel.

The parser 734 parses video information and audio information from the packet stream outputted from the channel buffer 832 in response to a parsing controlling signal 767 transmitted from the background image processing controller 810, outputs the parsed video information to the video buffer 736, and provides the parsed audio information to the audio buffer 738.

The video decoder 740 decodes the video information stored in the video buffer 736 in response to the video decoding controlling signal 771, and outputs the decoded video information. Here, the video information is decoded with reference to audio(A)/video(V) synchronization.

The audio decoder 742 decodes the audio information stored in the audio buffer 738 in response to an audio decoding controlling signal 769 when the audio information corresponds to a broadcasting channel set to enable audio output by the user, and outputs the decoded audio information. Here, the audio information is decoded with reference to audio(A)/video(V) synchronization.

The outputting section 750 includes a video outputting section 752 and an audio outputting section 754.

The video outputting section 752 provides the video information decoded by the video decoder 740 to a displaying section 780 in response to the video output controlling signal 773. In this case, the displaying section 780 displays periodically an image corresponding to the provided video information on a displaying area set as the background image by the user. Here, the displaying section 780 may be for example LCD.

The audio outputting section 754 provides the audio information decoded by the audio decoder 742 to a sound outputting section 790 in response to the audio output controlling signal 775. In this case, the sound outputting section 790 outputs a sound corresponding to the provided audio information at a given time, and may have a speaker 792 and an earphone 794.

The methods and apparatuses for providing the background image may be employed in devices receiving a terrestrial DMB, a satellite DMB, or a DVB. Here, the device may be a mobile communication device, a personal digital assistant (PDA), a portable multimedia player (PMP), a DMB receiving device such a navigation apparatus mounted to a car, or a play station, etc. Additionally, the device may be a laptop, a PC, etc. Further, the method of providing the background image and the apparatus for performing the same of the present embodiment may be employed in a device for receiving a digital TV broadcasting.

In the apparatus of providing the background image in FIGS. 7 and 8, the broadcasting programs of broadcasting channels are displayed on the displaying areas. However, the apparatus may display frames extracted from broadcasting signal of one broadcasting channel on the displaying areas. For example, in case that the displaying areas are composed of a first displaying area, a second displaying area and a third displaying area, nth frame, (n+k)th frame and (n+2k)th frame are respectively displayed on the first through third displaying areas, wherein k is natural number.

In another example embodiment of the present invention, the apparatus may display in sequence frames extracted as one frame for every unit of given number of frames from broadcasting signal of one broadcasting channel on the whole background screen, i.e. one displaying area. For example, nth frame, (n+k)th frame, (n+2k)th frame, etc, i.e. frames extracted as one frame for every unit of k frames are displayed in sequence on the whole background screen, wherein k is natural number.

In still another example embodiment of the present invention, the apparatus may display in turn broadcasting programs of broadcasting channels on the whole background screen.

Hereinafter, the apparatus for providing the background image employed in for example a mobile communication device will be described in detail with reference to FIG. 9.

FIG. 9 is a block diagram illustrating a mobile communication device employing the apparatus for providing a background image according to one example embodiment of the present invention.

In FIG. 9, the mobile communication device includes a controller 900, a key inputting section 920, a displaying section 930, a broadcasting receiving section 950, a transceiver 955, a call sound generating section 960, a voice processing section 965 and a sound outputting section 970.

The key inputting section 920 inputs various functions and operations of the device.

The sound outputting section 970 includes a speaker 972 and/or an earphone 974.

The sound outputting section 970 has the same constitution as the sound outputting section 790 in FIG. 7 and FIG. 8.

The displaying section 930 is made up of for example LCD, and has the same constitution as the displaying section 780 in FIG. 7 and FIG. 8.

The controller 900 includes a background image processing section 910. Here, the background image processing section 910 has the same constitution as the background image processing sections 700 and 800 in FIG. 7 and FIG. 8.

The controller 900 receives a signal processed by the broadcasting receiving section 950 and the transceiver 955, and controls operation of elements of the device using the received signal. Here, the background image processing section 910 controls especially operation of setting the received broadcasting to the background image and playing the broadcasting.

The broadcasting receiving section 950 may receive a terrestrial DMB signal, a satellite DMB signal, and a DVB signal.

A memory 980 stores temporarily data generated during execution of an operation system (OS) program of the controller 900 and an OS program of the device. Further, the background image information storing section 760 in FIG. 7 and FIG. 8 may be included in the memory 980, or may be disposed outside the memory 980.

The voice processing section 965 demodulates voice data inputted from the transceiver 955 and voice data stored in the memory 980 into a voice signal, and outputs the voice signal through the speaker 972 and the earphone 974. In addition, an audio signal decoded by the background image processing section 910 is outputted through the speaker 972 or the earphone 974, and is not shown.

The call sound generating section 960 outputs a call sound through the speaker 970 under control of the controller 900 when receiving a call, and outputs a receiving voice through the speaker 970 during telephone conversation.

The transceiver 950 converts a first RF signal received through an antenna into a first base band signal, converts a second base band signal transmitted from the controller 900 into a second RF signal, and outputs the second RF signal through the antenna.

Any reference in this specification to one embodiment, an embodiment, example embodiment, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of providing a background image in a portable device comprising:
extracting broadcasting signals of broadcasting channels in a given order on the basis of a background image setting information; and
displaying broadcasting images corresponding to the broadcasting signals as the background image on corresponding displaying areas of the portable device.

2. The method of claim 1, wherein the broadcasting image corresponding to frames extracted as one frame for every unit of k frames from each of the broadcasting images is displayed on a corresponding displaying area, and wherein k is a natural number.

3. The method of claim 2, wherein a value of k varies depending upon the displaying areas.

4. The method of claim 1, wherein only one of the broadcasting images displayed on each of the displaying areas are updated at a time.

5. The method of claim 1, wherein the step of displaying the broadcasting images includes:
displaying a still image corresponding to a specific frame in each of the broadcasting signals of the broadcasting channels on a corresponding displaying area; and
displaying a moving image corresponding to frames extracted in sequence one in unit of k frames from each of the broadcasting signals of the broadcasting channels on the corresponding displaying area after a given time from a time point of the displaying the still image, wherein k is a natural number.

6. The method of claim 1, wherein when one of the displaying areas is selected by a key inputting event, a broadcasting image of a broadcasting channel corresponding to the selected displaying area is played with a full screen on the portable device.

7. The method of claim 6, wherein in case that one of the displaying areas is selected by the key inputting event, detailed information concerning a broadcasting channel corresponding to the selected displaying area is displayed.

8. The method of claim 1, wherein the broadcasting channels are demodulated by using a plurality of tuners and demodulators.

9. The method of claim 1, wherein the broadcasting channels are demodulated by using one tuner and one demodulator.

10. The method of clam 1, wherein at least one of the broadcasting channels include one of a terrestrial DMB channel and a satellite DMB channel.

11. The method of claim 1, wherein an audio output of a predetermined broadcasting channel is activated during the displaying the broadcasting images.

12. The method of claim 1, wherein the method of providing the background image in the portable device is performed during an idle status of the portable device.

13. The method of claim 1, further comprising:
setting the background image setting information having the broadcasting channels to be used as the background image of the portable device.

14. The method of claim 1, wherein the background image setting information includes at least one of a displaying area information representing displaying areas corresponding to each of the broadcasting channels and an information representing a broadcasting channel of which audio output is enabled.

15. The method of claim 1, wherein the displaying areas are formed by dividing a background screen of the portable device into N areas, and wherein N is a natural number equal to or greater than two.

16. An apparatus for providing a background image in a portable device, the apparatus comprising:
a broadcasting receiving section configured to extract broadcasting signals of broadcasting channels in a given order on the basis of a background image setting information; and
a background image processing section configured to decode the extracted broadcasting signals, and configured to display broadcasting images corresponding to the decoded broadcasting signals as the background image on corresponding displaying areas of the portable device.

17. The apparatus of claim 16, wherein the background image processing section displays an image corresponding to frames extracted in sequence one in unit of k frames from each of the broadcasting channels on corresponding displaying area, wherein k is a natural number.

18. The apparatus of claim 16, wherein the broadcasting receiving section has tuners and demodulators.

19. The apparatus of claim 16, wherein the broadcasting receiving section has one tuner and one demodulator.

20. A portable device comprising:
a broadcasting receiving section configured to extract broadcasting signals of broadcasting channels in a given order on the basis of background image setting information; and
a background image processing section configured to decode the extracted broadcasting signals, and configured to display broadcasting images corresponding to the decoded broadcasting signals as a background image on corresponding displaying areas.

21. The portable device of claim 20, wherein frames extracted in sequence one in unit of k frames from each of the broadcasting channels are displayed on corresponding displaying area in given order.

22. A method of providing a background image in a portable device comprising:
extracting a broadcasting signal of a broadcasting channel on the basis of a background image setting information; and
displaying a broadcasting image of the broadcasting channel as a background image on at least one of displaying areas of the portable device during an idle status of the portable device.

23. The method of claim 22, wherein the step of the extracting a broadcasting signal includes extracting a plurality of frames from the broadcasting channel on the basis of the background image setting information, the frames being different from one another, and wherein the step of the displaying a broadcasting image includes displaying the extracted frames as the background image on one displaying area, the extracted frames being sequentially displayed in a given interval.

24. The method of claim 22, wherein the step of the extracting a broadcasting signal includes extracting a plurality of frames from the broadcasting channel on the basis of the background image setting information, the frames being different from one another, and wherein the step of the displaying a broadcasting image includes displaying the extracted frames as the background image on a plurality of displaying areas, the extracted frames being sequentially displayed in a given interval.

25. A method of providing a background image in a portable device comprising:
extracting broadcasting signals of broadcasting channels on the basis of a background image setting information; and
displaying broadcasting images corresponding to the broadcasting signals of the broadcasting channels as a background image on a displaying area of the portable device during an idle status of the portable device, the broadcasting images being displayed in a given interval on the displaying area.

26. The method of claim 25, wherein the background image setting information has an information representing the broadcasting channels to be set as the background image.

27. The method of claim 26, wherein the background image setting information further includes an information representing an enable of an audio output of one of the broadcasting channels.

28. A portable device comprising:
a broadcasting receiving section configured to extract a broadcasting signal of one broadcasting channel on the basis of a background image setting information; and
a background image processing section configured to display a broadcasting image corresponding to the broadcasting signal of the broadcasting channel as a background image on at least one displaying area of the portable device during an idle status of the portable device.

29. A portable device comprising:
a broadcasting receiving section configured to extract broadcasting signals of broadcasting channels on the basis of background an image setting information; and
a background image processing section configured to display broadcasting images corresponding to the broadcasting signals of the broadcasting channels as a background image on a displaying area of the portable device during an idle status of the portable device, the broadcasting images being displayed in a given interval on the displaying area.
